(19) United States
(12) Patent Application Publication
(10) Pub. No.: US 2023/0234753 A1
(43) Pub. Date: Jul. 27, 2023

(54) VALVED CAP FOR CONTAINER

(71) Applicant: Elias Roman, Mt. Vernon, OH (US)

(72) Inventors: Elias Roman, Mt. Vernon, OH (US); Charles A. McCusker, Canal Winchester, OH (US)

(21) Appl. No.: 17/583,692

(22) Filed: Jan. 25, 2022

(51) Int. Cl. B65D 41/04; B65D 81/36; B65D 41/26

(52) U.S. Cl. CPC B65D 41/0407; B65D 81/36; B65D 41/0442; B65D 41/26; A61J 19/02

(57) ABSTRACT

A cap on a bottle is selectively opened to permit passage of liquid to and from the chamber and closed to prevent passage of liquid. The cap has a collar that threads onto the bottle's mouth and a shroud that moves relative to the collar by applying a longitudinal force to the shroud's shoulder. By applying the force, the shroud moves longitudinally toward the bottle. In some embodiments, a valve is thereby rotated to unblock a throat so that liquid may pass from the opening defined by the shoulder to the chamber in the receptacle. In other embodiments, a dome is thereby displaced longitudinally to unblock the throat so that liquid may pass through.

### BACKGROUND OF THE INVENTION

The invention relates generally to a cap for a container, and more particularly to a cap that has a valve that, in one position, permits the passage of liquid, and in another position prevents the passage of liquid, through the cap between the exterior of the container and the interior of the container.

It is well known that humans commonly wish to expel saliva and other liquid contents from their mouths. For example, it is common for dental patients to expel into a sink or cup the water, saliva and toothpaste mixture that results from an ordinary dental cleaning. In another example, it is common for those chewing tobacco or other substances to spit out the saliva that is produced by the body when powdered tobacco, such as “snuff,” or leaf tobacco is placed in the mouth. Some of the tobacco/saliva mixture is consumed by the tobacco user, but much of the mixture is typically ejected from the mouth by the user.

When a person is using tobacco and expects to spit frequently, it is common for him or her to plan to be in an area where the mixture can be ejected onto the ground (e.g., on the dirt or grass of a baseball field). As an alternative, the user may carry a receptacle into which the liquid can be ejected. A disposable paper or plastic cup is a common receptacle for tobacco users, because such cups can be discarded rather than requiring cleaning of a substance that others find objectionable. However, disposable cups are easily spilled, creating a mess due to the large volume of the collected liquid.

Because of the risk of spilling the contents of disposable cups, disposable plastic bottles, such as those that contain water or soda, are commonly used instead. Such bottles have a replaceable lid that can be returned immediately after spitting into the chamber of the bottle, thereby preventing spilling even if the bottle falls over. However, two hands are required to remove and replace a lid on such a bottle. People who chew tobacco while working, driving or engaging in any task that requires both hands will not normally stop to remove and replace the bottle lid to spit.

Therefore the need exists for a device that forms a receptacle for liquid that is expelled from the human mouth that does not require both hands to operate.

### SUMMARY OF THE INVENTION

Disclosed herein is a cap for removably mounting to a receptacle that has a chamber. The cap comprises a shroud having a sidewall that extends from a shoulder near a first shroud end to an opposite second shroud end. The shoulder defines an opening to a passage that extends longitudinally through the shroud from the first shroud end to the second shroud end. A cradle has a substantially cylindrical collar configured for attachment to the receptacle and defining at least one throat therethrough. The cradle is mounted at least partially in the shroud. The shroud is configured for movement relative to the cradle, which is accomplished by applying a longitudinal force to the shroud. This force moves the cap between a closed configuration, in which the at least one throat is at least partially blocked to the flow of liquid, and an open configuration, in which the at least one throat is not blocked and liquid may flow through the longitudinal passage between the opening and the chamber.

In some embodiments a valve is disposed adjacent the throat of the cradle within the longitudinal passage of the shroud. The valve is configured for rotation relative to the cradle by applying a longitudinal force to the shroud. In some embodiments, the valve has a first axis of rotation relative to the shroud and a second axis of rotation relative to the cradle. The first and second axes are substantially parallel. In some embodiments, the valve has a yoke with at least one yoke section that is selectively disposed in the throat of the cradle in the closed configuration.

In some embodiments, at least first and second legs extend longitudinally from the shroud to a dome with gaps therebetween. This defines first and second passages between the shoulder, the legs and the dome. At least first and second funnel ramps may extend from the cradle and define at least first and second slots therebetween into which the first and second legs are disposed. The funnel ramps may define the throat, and the dome may be selectively disposed over the throat in the closed position, and spaced from the throat in the open position. In some embodiments, the legs may be deformed when the shroud is moved from the closed position to the open position, thereby biasing the cap to the closed position.

Disclosed herein is a cap removably mounted to a receptacle that has a chamber. The cap comprises a shroud having a sidewall that extends from a shoulder near a first shroud end to an opposite second shroud end. The shoulder defines an opening to a passage that extends longitudinally through the shroud from the first shroud end to the second shroud end. A cradle has a substantially cylindrical collar attached to the receptacle and defines at least one throat therethrough. The cradle is mounted at least partially in the shroud and the shroud is configured for movement relative to the cradle by applying a longitudinal force to the shroud. A valve mounts to the cradle adjacent the at least one throat and in the longitudinal passage of the shroud. The valve is rotatably mounted to the cradle and configured to move between a closed configuration, in which the throat is at least partially blocked by a section of the valve, and an open configuration, in which the throat is not blocked.

In some embodiments, the valve has at least a first axle with a first axis of rotation relative to the shroud and at least a second axle with a second axis of rotation relative to the cradle. The first and second axes are substantially parallel, the at least first axle rotatably mounts to the shroud and the at least second axle rotatably mounts to the cradle. In some embodiments, the valve has a yoke with at least one yoke section that is the section of the valve that is selectively disposed in the throat of the cradle in the closed configuration.

Disclosed herein is a cap removably mounted to a receptacle that has a chamber. The cap comprises a shroud having a sidewall that extends from a shoulder near a first shroud end to an opposite second shroud end. The shoulder defines an opening to a passage that extends longitudinally through the shroud from the first shroud end to the second shroud end. At least first and second legs extend longitudinally from the shroud to a dome with gaps therebetween, thereby defining first and second passages between the shoulder, the legs and the dome. A cradle has a substantially cylindrical collar attached to the receptacle and at least first and second funnel ramps defining at least first and second slots therebetween into which the first and second legs are disposed. The funnel ramps define a throat. The cradle mounts at least partially in the shroud. The cap permits relative longitudinal movement between the shroud and the cradle by a longitudinal force applied to the shoulder. This moves the shroud relative to the cradle to selectively dispose the dome over the throat to a closed position, in which liquid is blocked from passing through the throat, and removing the dome from the throat to an open position in which liquid is permitted to pass through the throat. In some embodiments, the legs are deformed when the shroud is moved from the closed position to the open position, thereby biasing the cap to the closed position.

### BRIEF DESCRIPTION OF THE DRAWINGS

FIG. 1 is a view in perspective illustrating an embodiment of the present invention.

FIG. 2 is a view in perspective illustrating a shroud component of the embodiment of FIG. 1.

FIG. 3 is a view in perspective illustrating a valve component of the embodiment of FIG. 1.

FIG. 4 is a view in perspective illustrating a cradle component of the embodiment of FIG. 1.

FIG. 5 is a view in perspective illustrating the embodiment of FIG. 1.

FIG. 6 is a section view in perspective illustrating the embodiment of FIG. 5 through the line 6-6.

FIG. 7 is a section view in perspective illustrating the embodiment of FIG. 5 through the line 7-7 in a first, closed, position.

FIG. 8 is a section view in perspective illustrating the embodiment of FIG. 5 through the line 7-7 in a second, intermediate, position.

FIG. 9 is a section view in perspective illustrating the embodiment of FIG. 5 through the line 7-7 in a third, open, position.

FIG. 10 is a bottom view in perspective illustrating the embodiment of FIG. 5 with the bottle removed.

FIG. 11 is a top view in perspective illustrating the embodiment of FIG. 5 with the bottle removed.

FIG. 12 is a view in perspective illustrating a second embodiment of the present invention.

FIG. 13 is a section view in perspective illustrating the embodiment of FIG. 12 through the line 13-13.

FIG. 14 is a side view illustrating a shroud component of the embodiment of FIG. 12.

FIG. 15 is a top view illustrating the shroud of FIG. 14.

FIG. 16 is a view in perspective illustrating a cradle component of the embodiment of FIG. 12.

FIG. 17 is a top view illustrating the cradle of FIG. 16.

FIG. 18 is a bottom view in perspective illustrating the embodiment of FIG. 12 with the bottle removed.

FIG. 19 is a top view in perspective illustrating the embodiment of FIG. 12 with the bottle removed.

FIG. 20 is a side view in section illustrating the embodiment of FIG. 19 through the line 20-20.

FIG. 21 is a section view in perspective illustrating the embodiment of FIG. 12 through the line 21-21 in a first, closed, position.

FIG. 22 is a section view in perspective illustrating the embodiment of FIG. 12 through the line 21-21 in a second, intermediate, position.

FIG. 23 is a section view in perspective illustrating the embodiment of FIG. 12 through the line 21-21 in a third, open, position.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

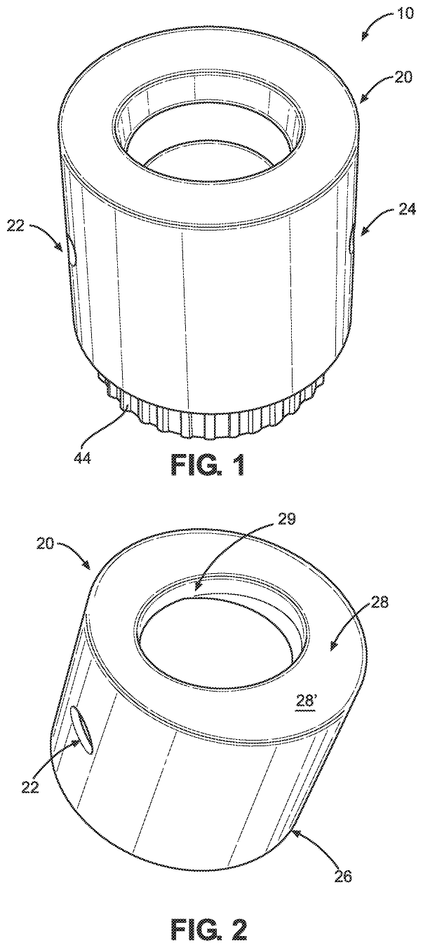

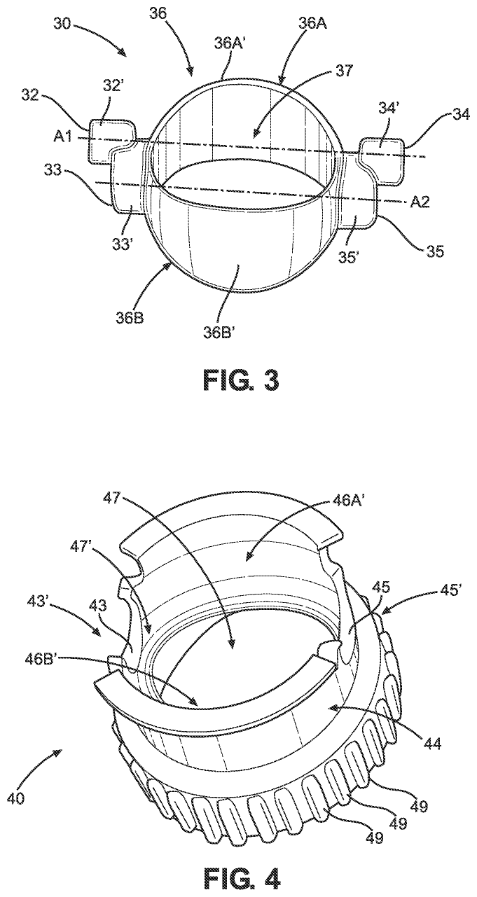

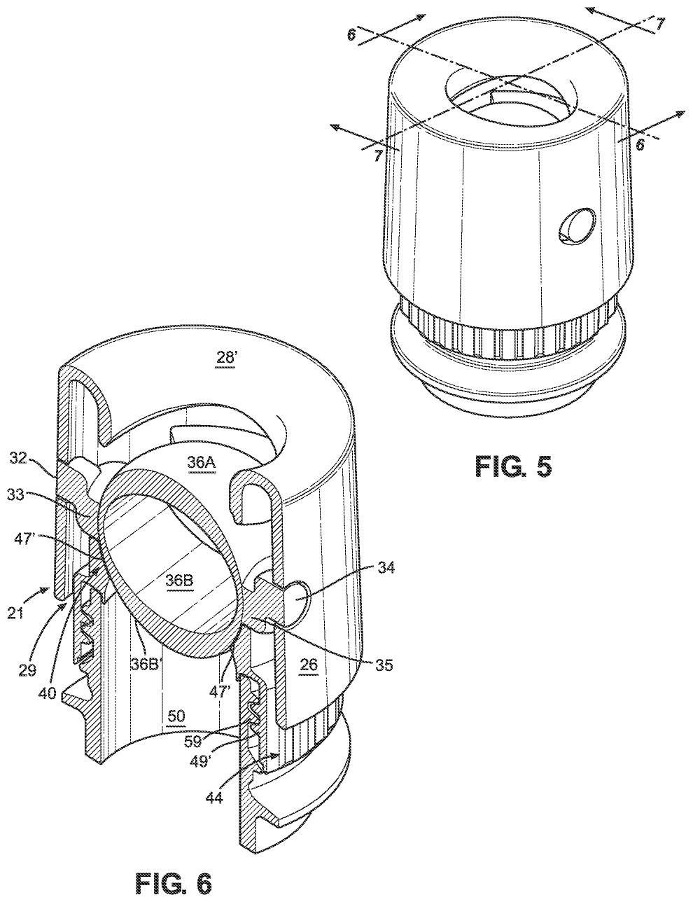

Embodiments of the present invention are shown in the illustrations. The components of a first cap 10 are shown in an assembled state in FIGS. 1 and 5, among others, and separately in FIGS. 2-4. The cap 10 has three main components: a shroud 20, a valve 30 and a cradle 40, and these components may be formed of plastic, metal, glass, ceramic or any other suitable material. These components may be manufactured separately and then assembled as described and shown herein or as understood by a person of ordinary skill, or they may be manufactured assembled, such as by 3-D printing. In the assembled cap 10, the components may move relative to one another to dispose the cap 10 in, or between, one of two extreme positions. In one extreme position the cap 10 is open and fluid may pass therethrough. In another extreme position the cap 10 is closed and fluid may not pass therethrough, or there is substantial resistance to fluid passing through. As the cap 10 transitions from one extreme position to the other extreme position, the components of the cap 10 are in various stages of permitting and restricting fluid from passing through.

In some embodiments, the cap 10 is threaded onto the corresponding threads of a mouth of a conventional bottle, such as a plastic water bottle or a plastic soda bottle, and thus the fluid that passes through the cap 10 may flow into the chamber of the conventional bottle. The cap 10 may be threaded onto any receptacle, and is not limited to those discussed herein. Furthermore, the cap may be attached to a receptacle using fasteners other than threads, such as a bayonet structure and others. It is contemplated that the receptacle that is fastened to the cap 10 has a chamber that may communicate with the exterior of the receptacle through a mouth or other opening structure to which the cap 10 may attach.

The shroud 20 has a substantially cylindrically-shaped sidewall 26 with apertures 22 and 24 formed in opposite circumferential sides of the sidewall 26. The shape of the apertures 22 and 24 may be circular or elongated, such as an oval or ellipse. An abutment end 28 defines one longitudinal end of the shroud 20 and has an opening 29 formed inside of a shoulder 28′. The shoulder 28′ extends around the end of the sidewall 26, and is preferably smooth and relatively wide, such as the width of a human lip. The shoulder 28′ may be between about one-eighth and about one-half inches wide.

The bottle end 21 of the sidewall 26 opposite the abutment end 28 (see FIG. 6) defines the opposite end of the opening 29 that passes through the shroud 20 and may be the shroud end that is closer to a bottle to which the cap 10 is attached. The sidewall 26 may have a thickness at the end 21 that is substantially less than the width of the shoulder 28′, and the thickness may be about one-sixteenth of an inch. The diameter of the shroud 20 may be one and one-half inches. These dimensions are examples of contemplated dimensions of a cap 10 used on a conventional water or soda bottle, and are not limiting. A person having ordinary skill will understand that a cap designed for a different bottle or receptacle may be much larger or much smaller.

The valve 30 has coaxial axles 32 and 34 protruding from opposite longitudinal ends of a yoke 36. The axles 32 and 34 preferably have cylindrical outer surfaces 32′ and 34′, respectively, and may extend, in an operable configuration, through the apertures 22 and 24, respectively. The surfaces 32′ and 34′ may seat against the portions of the sidewall 26 that define the apertures 22 and 24. An axis Al, defined by the cylindrical outer surfaces 32′ and 34′, extends through the axles 32 and 34.

Two other coaxial axles 33 and 35, which have cylindrical outer surfaces 33′ and 35′, respectively, protrude from opposite longitudinal ends of the yoke 36 adjacent the axles 32 and 34. An axis A2 defined by the cylindrical outer surfaces 33′ and 35′ is substantially parallel to the axis Al and is offset radially therefrom.

The yoke 36 is made up of two yoke sections 36a and 36b with an aperture 37 defined therebetween. The aperture 37 is large enough to permit liquid to pass through, and in some embodiments may be between 0.5 to 1.0 inches wide. The yoke sections 36a and 36b have outer surfaces 36a′ and 36b′ that may be spherical and face outwardly from the aperture 37. The outer surfaces 36a′ and 36b′ are coaxial with the axis A2.

The cradle 40 has two bearing surfaces 43 and 45 defining voids 43′ and 45′ that are formed in a substantially cylindrical collar 44. The surfaces 43 and 45 may be circular cylindrical (or at least a portion of a circular cylinder) and coaxial with one another. The collar 44 may be a circular cylinder that is substantially coaxial with the axis of the sidewall 26 when the cap 10 is fully assembled. Radially outwardly extending ribs 49 are formed around the exterior of the collar 44 to facilitate and improve the grip of a human user rotating the collar 44 while threading onto the bottle 50. Radially-inwardly extending threads 49′ may be formed near one end of the collar 44 and configured to receive the outwardly-extending threads 59 on the mouth of a common water or soda bottle 50 (see FIG. 6 — only a portion of the water or soda bottle is shown). Any other fastener to attach to any other container is contemplated to substitute for the threads.

The interior of the central portion of the collar 44 includes a throat 47 defined by a cradle void surface 47′ at the lower end (in the orientation of FIG. 4) of the opposing first and second surfaces 46a′ and 46b′. The cradle void surface 47′ extends entirely around the collar 44 and defines the throat 47 that forms the passage through the cradle 40. The first surface 46a′ may have a spherical contour similar to the contour of the spherical surface 36a′.

The second surface 46b′ may have a spherical contour similar to the contour of the spherical surface 36b′. The first and second surfaces 46a′ and 46b′ may be coaxial with the surfaces 43 and 45.

When the cap 10 is assembled, as shown in FIGS. 1, 5 and 6, the valve 30 is inserted in the shroud 20 until the axles 32 and 34 are inserted in the apertures 22 and 24, respectively. Next, the cradle 40 may be inserted until the axles 33 and 35 are inserted in the voids 43′ and 45′, respectively. In this configuration, at least a portion of the valve 30, such as the yoke 36, is disposed in or near the throat 47 with the axles 33 and 35 resting in the voids 43′ and 45′, respectively. The cylindrical surfaces 33′ and 35′ seat against the bearing surfaces 43 and 45, respectively, and are able to move relative thereto. The surface 36a′ is disposed in a sealing relationship with the surface 46a′ and the surface 36b′ is disposed in a sealing relationship with the surface 46b′. Because of these sealing relationships, no liquid may pass through a gap between the surfaces 36a′ and 46a′, nor may liquid pass through a gap between the surfaces 36b′ and 46b′. When any surface is in a sealing relationship with another surface, no liquid may pass therebetween. In an alternative embodiment, a very small amount of liquid my pass slowly through these gaps so as to effectively prevent substantial liquid passage.

Because of the cooperation between the coaxial cylindrical surfaces 33′ and 35′ with the coaxial cylindrical surfaces 43 and 45, the valve 30 may rotate about the axis A2 of the cylindrical surfaces 33′ and 35′ while the surfaces 46a′ and 46b′ maintain their radial proximity with the surfaces 36a′ and 36b′, respectively. The surfaces 46a′ and 46b′ are also coaxial with the cylindrical surfaces 33′ and 35′ when the valve 30 is mounted in the cradle 40. Thus, when the valve 30 rotates about the axis A2 of the cylindrical surfaces 33′ and 35′, the spherical surfaces 36a′ and 36b′ are not extended radially outwardly or inwardly from the axis of rotation. This permits the spherical surfaces 36a′ and 36b′ to rotate relative to the spherical surfaces 46a′ and 46b′ without significant resistance while maintaining the same relative radial positions and sealing relationships.

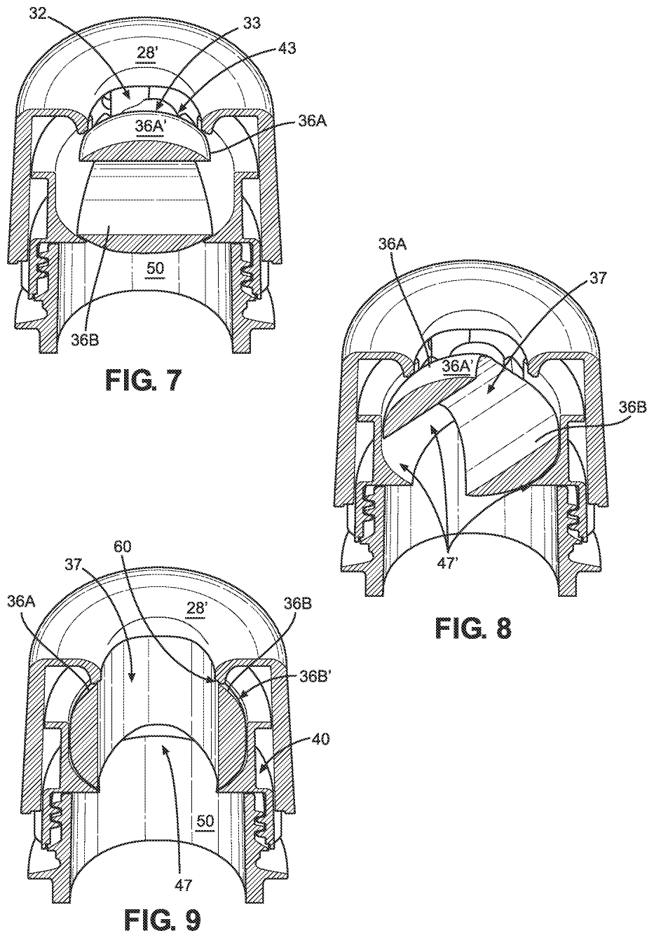

The cap 10 thus has components that move relative to one another. The shroud 20 may move longitudinally relative to the valve 30 and the cradle 40, and the valve 30 may rotate relative to the cradle 40 and the shroud 20. The fully assembled cap 10 is in a “resting configuration” when no substantial external forces are applied to the cap 10, and this is preferably when the cap is in the “closed” position or configuration, which is shown in FIGS. 6 and 7. The cap maintains the resting configuration due to a coil spring, leaf spring, or another bias (not shown), which may include gravity, tending to position the valve 30 relative to the cradle 40 to close off any passage(s) through the aperture 29. In order to move to the open configuration, a force must be applied that overcomes the bias.

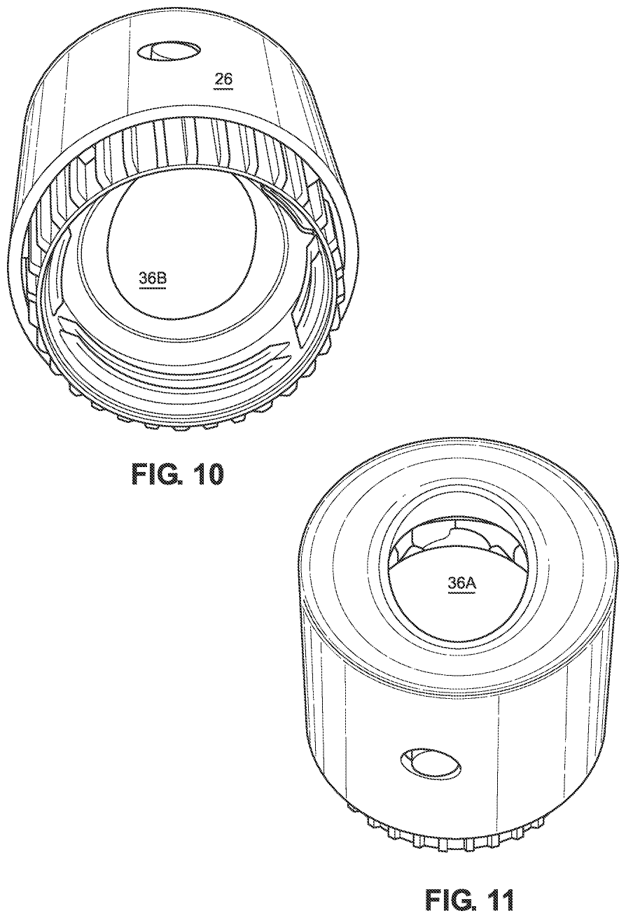

As shown in FIGS. 6, 7 and 10, in the closed configuration the valve 30 is disposed in the cradle 40 with the yoke section outer surface 36b′ seating in a sealing relationship against the cradle void surface 47′. In this configuration, the yoke section 36b obstructs the throat 47 by the surface 36b′ sealingly seating against the cradle void surface 47′, thereby preventing any liquid, and possibly any gas, from passing through the throat 47, and therefore the cap 10. Thus, any liquid in the bottle 50 may not flow through the cap 10 and out of the bottle in the closed configuration. In an alternative, a small amount of liquid may pass slowly through the cap 10 due to an imperfect seal.

In order to move the cap from the closed configuration shown in FIG. 7 to the open configuration shown in FIG. 9, the valve 30 must be rotated about 90 degrees relative to the cradle 40. In order to do this, the shroud 20 is first moved longitudinally relative to the cradle 40, such as by applying a longitudinal force to the shoulder 28′ toward the collar 40. In a contemplated scenario, this may be accomplished by a human user pressing his lip against the shoulder 28′ while holding the bottle 50, to which the cap 10 is attached, in one hand. This may be carried out by an action similar to a human user raising such a bottle to his or her lips to drink, but without taking in any liquid, and by pressing the shoulder 28′ against the lower lip with a greater force than he or she would press the mouth of the bottle against the lower lip to seal against leakage when drinking.

This longitudinal force applied by the user is transferred from the shoulder 28′ of the shroud 20 to the axles 32 and 34. Because the axis Al of the axles 32 and 34 is disposed radially from the axis A2 of the axles 33 and 35 (with is radially outwardly of the longitudinal axis of the shroud 20), the longitudinal force applied to the shroud 20 is transferred to the axles 32 and 34, which applies a torque to the valve 30 about the axis A2. A sufficient torque causes the valve 30 to rotate about the axis A2 of the axles 33 and 35 as the shroud 20 is displaced longitudinally toward the bottle 50. This torque moves the axles 32 and 34 along an arcuate path around the axis A2 and rotates the axles 33 and 35 within the bearing surfaces 43 and 45. Upon the application to the shroud 20 of a sufficient longitudinal force, the shroud 20 moves longitudinally toward the bottle 50 and rotates the valve 30 sufficiently to move the yoke section 36b at least partially out of registration with the cradle void surface 47′ to the position shown in FIG. 8. In the FIG. 8 configuration, the axis of the aperture 37 has rotated sufficiently to open a passage so that liquid on one side of the cap 10 may pass through the throat 47.

Upon the continued application of a sufficient longitudinal force to the shoulder 28′, the rotation of the valve 30 continues until the valve 30 reaches the position shown in FIG. 9, which is the open configuration. In the open configuration, the shroud 20 has been moved longitudinally sufficiently to rotate the valve 30 to the position shown, which may be at the rotational limit of the valve 30. In this position, one edge of each of the yoke sections 36a and 36 seats against the inside edge of the shoulder 28′ to create a juncture 60 that is preferably a sealing relationship that prevents any liquid from passing between the valve 30 and the shroud 20. Instead, all liquid that enters the opening 29 passes through the valve aperture 37, the throat 47 and into the chamber of the bottle 50.

Once access is gained by the user to the chamber of the bottle 50, the user may expel his or her saliva mixture or other liquid through the aligned aperture 37 and throat 47. After this expulsion, the user may release the longitudinal force he or she had been applying to the shoulder 28′ by lifting his or her lip from the shoulder 28′ while still holding the bottle in one hand. This removal or sufficient decrease of the longitudinal force causes the reverse rotation of the valve 30, which may be biased in this direction by a torsion or leaf spring disposed between the valve 30 and the shroud 20, or the valve 30 and the cradle 40. This rotation of the valve 30 continues until it moves the cap 10 through the configuration shown in FIG. 8 back to the closed configuration, as shown in FIG. 7. In the closed configuration, the liquid just placed in the bottle, along with any other liquid in the bottle, will not flow out of the bottle. This is because the cap 10 is sealed in the closed configuration, and will not leak even if the bottle falls over, because the yoke section 36b seals against the cradle void surface 47′ all around the throat 47. This seals the contents of the bottle from passing through the cap 10. When the bottle is full or use is no longer needed, the entire structure may be discarded, the cap may be removed (to be cleaned) and the bottle discarded, or both the cap and the bottle may be cleaned and re-used.

The apertures 22 and 24 may be elongated to permit the arcuate movement of the axles 32 and 34 about the axis A2 of the axles 33 and 35. Thus, when the shroud 20 is displaced longitudinally from the position shown in FIG. 7 and the axis Al of the axles 32 and 34 is driven by the shroud 20 along an arcuate path about the axis A2, the elongated apertures 22 and 24 accommodate the lateral component of arcuate movement of the axles 32 and 34.

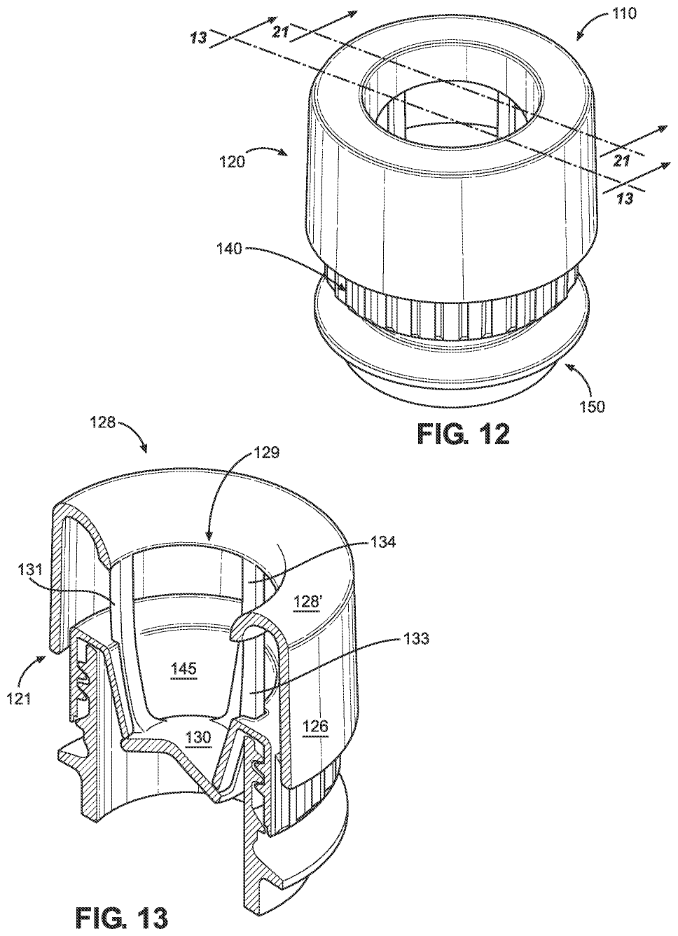

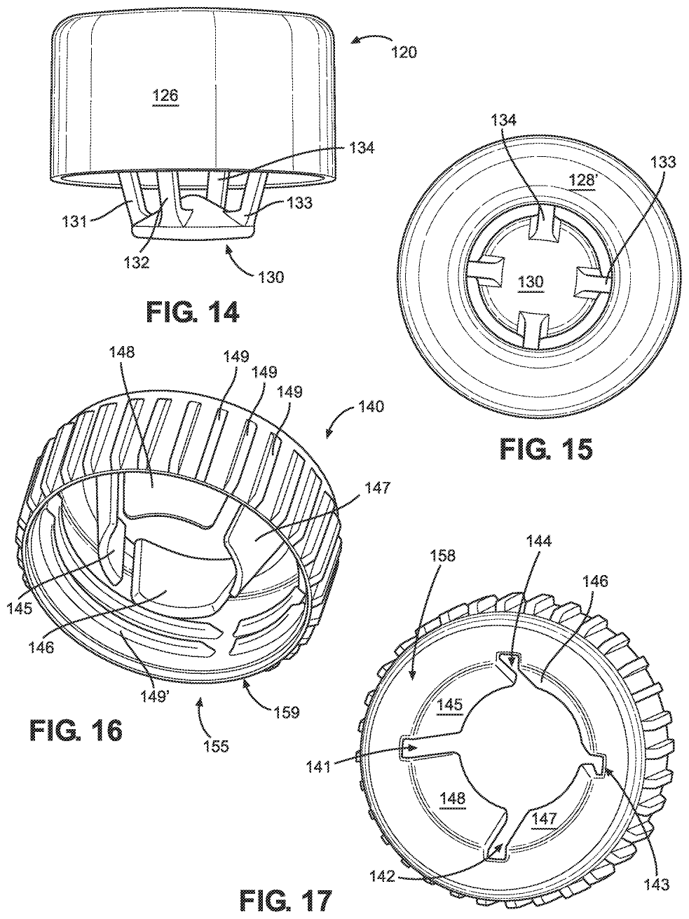

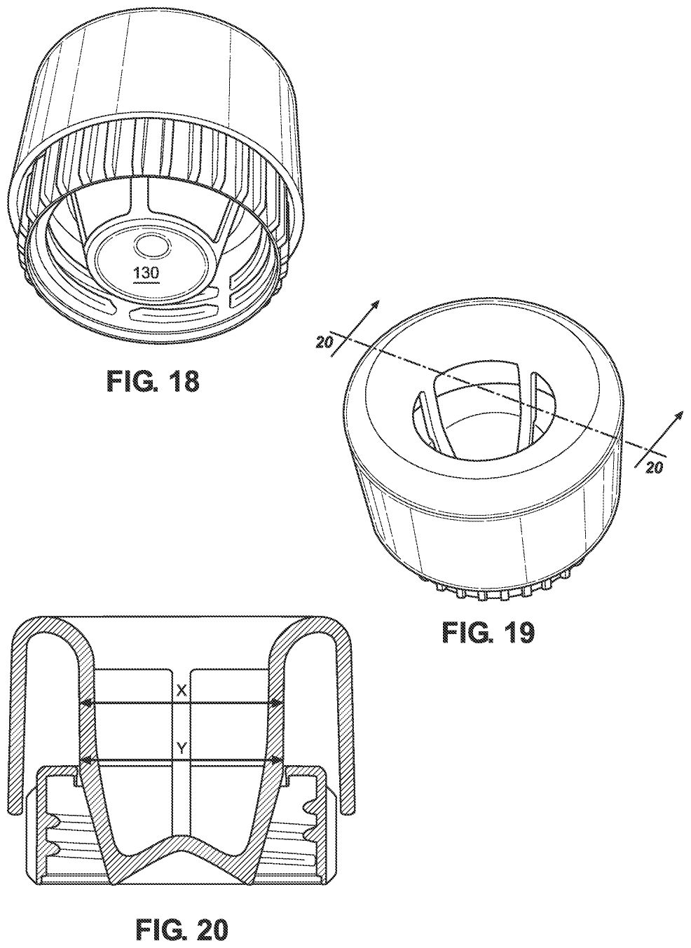

A second embodiment of the present invention is shown in FIGS. 12-23 in a cap 110 with two main components: a shroud 120 and a cradle 140. These components may be formed of plastic, metal, glass, ceramic or any other suitable material. The components are shown separately in FIGS. 14-17 and fully assembled in FIGS. 12 and 18-20. A bottle 150 is shown in an operable attachment position in some of the illustrations. As with the embodiment described above, any suitable container may substitute for the bottle 150.

The shroud 120 has a substantially cylindrical sidewall 126 with a shoulder 128′ at a first longitudinal end 128. An opening 129 through the first end 128 extends between the sides of the circumferential shoulder 128′. A second longitudinal end 121 defines the opposite end of the sidewall 126 and the opening 129 that passes through the sidewall 126. Four legs 131, 132, 133 and 134 extend from near the first end 128, in the opening 129, of the shroud 120 longitudinally toward and past the second end 121, defining gaps therebetween that form a passage for liquid through the shroud 120. The legs 131-134 attach to a dome 130 at the lower end, in the orientation of FIG. 14.

The cradle 140 has a substantially cylindrical collar 155 with threads 149′ extending radially inwardly and ribs 149 extending radially outwardly. The slots 141, 142, 143 and 144 are defined by the edges of the funnel ramps 145, 146, 147 and 148, and the slots 141-143 receive the legs 131-134 when the cap 110 is assembled. The funnel ramps 145-148 extend from attachment at one longitudinal end 158 of the cradle 140 toward the opposite longitudinal end 159, which end 159 defines a throat that accepts the threaded mouth of the bottle 150 or any other receptacle. The funnel ramps 145-148 extend from the cradle in the manner of cantilevers.

When assembled in an operable configuration, as shown in FIGS. 12-13 and 18-23, the shroud 120 is positioned around the cradle 140, and the cradle may be attached to a bottle 150. When no forces are applied to the cap 110, the cap 110 may be in the closed position in which the dome 130 is in a sealing relationship with the ends of the ramps 145-148 farthest from the shoulder 128′, the legs 131-134 are in a sealing relationship with the sides of the ramps 145-148 and the edge of the shoulder 128′ that defines the opening 129 is in a sealing relationship with the longitudinal end 158 of the cradle 145.

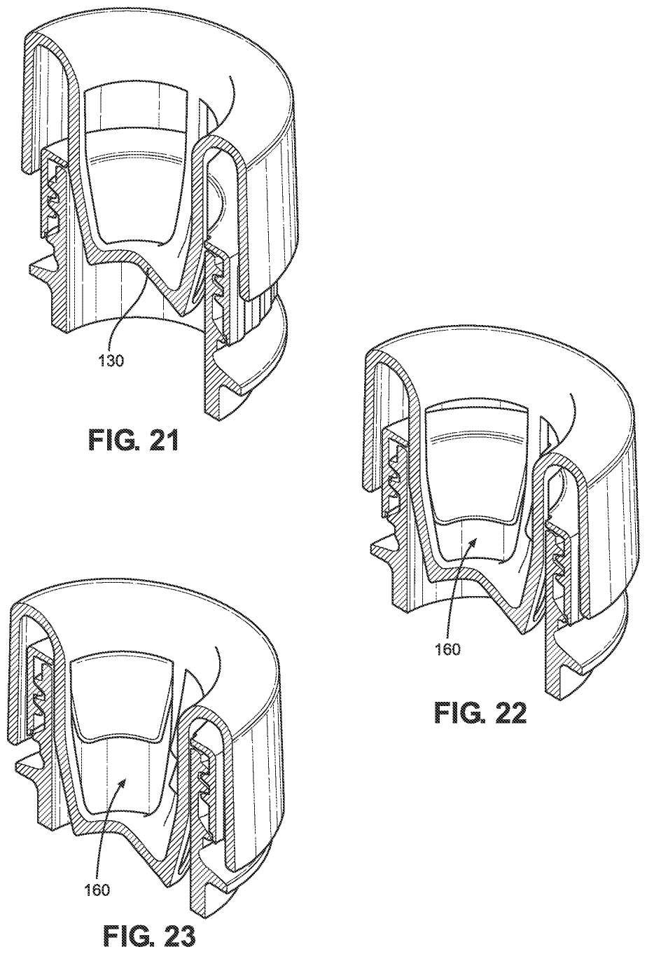

The shroud 120 may slide longitudinally relative to the cradle 140 by the legs 131-134 moving within the slots 141-144 of the cradle 140. This may be as a result of a longitudinal force being applied by a user's lip to the shoulder 128′ in the direction of the cradle 140 while holding the exterior of the bottle 150 in one hand, as described above for the embodiment shown in FIGS. 1-11. The force applied to the shroud 120 displaces the shroud 120 longitudinally from the closed position shown in FIG. 21 toward the intermediate position shown in FIG. 22.

During the displacement from the closed position, the legs 131-134 slide in the slots 141-144, respectively, and the radially outwardly facing surfaces of the legs may slide against the radially inwardly facing surfaces of the slots. The legs 131-134 may have radially outwardly facing surfaces that are slightly wider at one end than the opposite. For example, the illustration of FIG. 20 (showing the closed position) indicates two widths, X and Y, between opposing outwardly facing surfaces of the legs 131-134. In one embodiment, the dimension X is greater than the dimension Y. Thus, when the shroud 120 is displaced downwardly in the orientation of FIG. 20, the legs 131-134 are forced by the movement relative to the structures that define the slots 141-144 to bend slightly inwardly, thereby functioning as leaf springs that tend to force the shroud 120 to the closed position of FIG. 21 when all forces are removed from the cap 110. Alternatively, X may be equal to Y and a coil or other spring may be inserted between the shroud 120 and the cradle 140, as will be understood by the person of ordinary skill, in order to bias the components of the cap 110 to the closed configuration.

With the embodiment shown in FIGS. 12-23, the shroud 120 may be moved from the closed position shown in FIG. 21 to the intermediate position of FIG. 22. In the closed position, the dome 130 is pressed against the ramps 145-148 and all contacting surfaces form sealing relationships to prevent liquid from passing through the cap. Upon movement to the intermediate position of FIG. 22, gaps 160 are formed that permit some liquid to pass through the cap 110. When the shroud 120 is moved to the open position of FIG. 23, the gaps 160 are sufficiently large that significant amounts of liquid may pass through the cap 110. Thus, a user whose lip is already on the shoulder 128′ may expel a liquid mixture through the opening 129, through the gaps 160, and into the bottle 150 chamber.

After expulsion of liquid from the mouth into the chamber, the user may release the longitudinal force applied against the shroud 120, at which time the bias tends to move the shroud 120 back to the closed position shown in FIG. 21. Thus, the user may open and close the cap 110 to permit liquid to pass through by simply raising the arm holding the receptacle, pressing the shroud against the lip with light pressure, and then releasing the longitudinal force. This permits one-handed use of the receptacle into which the user expels the liquid.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A cap for removably mounting to a receptacle that has a chamber, the cap comprising:
(a) a shroud having a sidewall that extends from a shoulder near a first shroud end to an opposite second shroud end, the shoulder defining an opening to a passage that extends longitudinally through the shroud from the first shroud end to the second shroud end; and
(b) a cradle having a substantially cylindrical collar configured for attachment to the receptacle and defining at least one throat therethrough, the cradle being mounted at least partially in the shroud;
wherein the shroud is configured for movement relative to the cradle by applying a longitudinal force to the shroud and thereby moving between a closed configuration, in which the at least one throat is at least partially blocked to the flow of liquid, and an open configuration, in which the at least one throat is not blocked and liquid may flow through the longitudinal passage between the opening and the chamber.

2. The cap in accordance with claim 1, further comprising a valve disposed adjacent the throat of the cradle within the longitudinal passage of the shroud, wherein the valve is configured for rotation relative to the cradle by applying a longitudinal force to the shroud.

3. The cap in accordance with claim 2, wherein the valve has a first axis of rotation relative to the shroud and a second axis of rotation relative to the cradle, wherein the first and second axes are substantially parallel.

4. The cap in accordance with claim 2, wherein the valve has a yoke with at least one yoke section that is selectively disposed in the throat of the cradle in the closed configuration.

5. The cap in accordance with claim 1, further comprising:
(a) at least first and second legs extending longitudinally from the shroud to a dome with gaps therebetween, thereby defining first and second passages between the shoulder, the legs and the dome;
(b) at least first and second funnel ramps extending from the cradle and defining at least first and second slots therebetween into which the first and second legs are disposed, the funnel ramps defining the throat, wherein the dome is selectively disposed over the throat in the closed position, and the dome is spaced from the throat in the open position.

6. The cap in accordance with claim 5, wherein the legs are deformed when the shroud is moved from the closed position to the open position, thereby biasing the cap to the closed position.

7. A cap removably mounted to a receptacle that has a chamber, the cap comprising:
(a) a shroud having a sidewall that extends from a shoulder near a first shroud end to an opposite second shroud end, the shoulder defining an opening to a passage that extends longitudinally through the shroud from the first shroud end to the second shroud end;
(b) a cradle having a substantially cylindrical collar attached to the receptacle and defining at least one throat therethrough, the cradle being mounted at least partially in the shroud, wherein the shroud is configured for movement relative to the cradle by applying a longitudinal force to the shroud; and
(c) a valve mounted to the cradle adjacent the at least one throat and in the longitudinal passage of the shroud, wherein the valve is rotatably mounted to the cradle and configured to move between a closed configuration, in which the throat is at least partially blocked by a section of the valve, and an open configuration, in which the throat is not blocked.

8. The cap in accordance with claim 7, wherein the valve has at least a first axle with a first axis of rotation relative to the shroud and at least a second axle with a second axis of rotation relative to the cradle, wherein the first and second axes are substantially parallel, the at least first axle rotatably mounts to the shroud and the at least second axle rotatably mounts to the cradle.

9. The cap in accordance with claim 7, wherein the valve has a yoke with at least one yoke section that is the section of the valve that is selectively disposed in the throat of the cradle in the closed configuration.

10. A cap removably mounted to a receptacle that has a chamber, the cap comprising:
(a) a shroud having a sidewall that extends from a shoulder near a first shroud end to an opposite second shroud end, the shoulder defining an opening to a passage that extends longitudinally through the shroud from the first shroud end to the second shroud end;
(b) at least first and second legs extending longitudinally from the shroud to a dome with gaps therebetween, thereby defining first and second passages between the shoulder, the legs and the dome;
(c) a cradle having a substantially cylindrical collar attached to the receptacle and at least first and second funnel ramps defining at least first and second slots therebetween into which the first and second legs are disposed, the funnel ramps defining a throat, wherein the cradle mounts at least partially in the shroud and permits relative longitudinal movement between the shroud and the cradle by a longitudinal force applied to the shoulder, thereby moving the shroud relative to the cradle to selectively dispose the dome over the throat to a closed position, in which liquid is blocked from passing through the throat, and removing the dome from the throat to an open position in which liquid is permitted to pass through the throat.

11. The cap in accordance with claim 10, wherein the legs are deformed when the shroud is moved from the closed position to the open position, thereby biasing the cap to the closed position.
